(19) United States
(12) Patent Application Publication
(10) Pub. No.: US 2019/0337856 A1
(43) Pub. Date: Nov. 7, 2019

(54) METAL-BASED ALUMINUM NITRIDE COMPOSITE MATERIAL AND PREPARATION METHOD THEREFOR

(71) Applicant: BYD COMPANY LIMITED, SHENZHEN, GUANGDONG (CN)

(72) Inventors: Chengchen LIU, Shenzhen (CN); Shanqing SONG, Shenzhen (CN); Changjian SHAO, Shenzhen (CN); Qiang XU, Shenzhen (CN); Xinping LIN, Shenzhen (CN)

(73) Assignee: BYD COMPANY LIMITED, SHENZHEN, GUANGDONG (CN)

(21) Appl. No.: 16/475,039

(22) PCT Filed: Dec. 8, 2017
(86) PCT No.: PCT/CN2017/115135

§ 371 Date: Jun. 28, 2019

(30) Foreign Application Priority Data
Dec. 29, 2016 (CN) 201611248588.8

(51) Int. Cl. C04B 35/581; C04B 35/622; C04B 38/00; C22C 1/10; C04B 41/48

(52) U.S. Cl. CPC C04B 35/581; C04B 35/622; C04B 38/00; C22C 1/10; C04B 41/4853; C04B 2235/3281; C22C 2001/1073; C04B 2235/3206; C04B 2235/3217; C04B 2235/3225; C04B 2235/3865; C04B 41/4869

(57) ABSTRACT

The present disclosure relates to the field of ceramics, and discloses a metal-based aluminum nitride composite material. The composite material includes an aluminum nitride ceramic skeleton and a metal filling at least part of pores of the aluminum nitride ceramic skeleton. The aluminum nitride ceramic skeleton contains aluminum nitride and CuAlO₂, and the aluminum nitride ceramic skeleton has a porosity of 20 to 40 percent. The present disclosure further discloses a method for preparing the metal-based aluminum nitride composite material and the metal-based aluminum nitride composite material obtained by the method. A CuAlO₂ substance is formed in the aluminum nitride ceramic skeleton obtained in the present disclosure.

### CROSS-REFERENCE TO RELATED APPLICATIONS

This application claims priority to and benefits of Chinese Patent Application No. 201611248588.8, filed with the State Intellectual Property Office of P. R. China on Dec. 29, 2016. The entire content of the above-referenced application is incorporated herein by reference.

### FIELD

The present disclosure relates to the field of ceramics, and more particularly relates to a metal-based aluminum nitride composite material and a fabrication method thereof.

### BACKGROUND

In most of the prior art, a volatile and labile pore former (such as resin, starch, etc.) is added into aluminum nitride powder. Pores are formed in positions of the pore former by volatilization of the pore former during sintering to fabricate a multi-porous aluminum nitride ceramic skeleton.

However, there is a need for further research and discovery of a novel composite material with improved compounding performance of aluminum nitride ceramic skeleton and metal and a fabrication method thereof.

### SUMMARY

The present disclosure provides a metal-based aluminum nitride composite material and a fabrication method thereof to overcome the defect of insufficient compounding performance of aluminum nitride ceramic skeleton and metal in the prior art.

Therefore, in order to achieve the above objective, in a first aspect, the present disclosure provides a metal-based aluminum nitride composite material. The composite material includes an aluminum nitride ceramic skeleton and a metal filling at least part of pores of the aluminum nitride ceramic skeleton. The aluminum nitride ceramic skeleton contains aluminum nitride and CuAlO₂, and has a porosity of 20 to 40 percent.

The inventors of the present disclosure have found that gas is generated by reaction of the aluminum nitride with cupric oxide or cuprous oxide during sintering, so that a plurality of pores is formed in situ in an aluminum nitride mixture. The pores among aluminum nitride particles make it easier to form through holes among the aluminum nitride particles by pressing molding under a mechanical pressure. The CuAlO₂ can be generated through the reaction of the aluminum nitride with the cupric oxide or cuprous oxide during the sintering. A composite material with higher bonding force between the aluminum nitride ceramic skeleton and the metal is obtained. The reason may be the better wettability of the CuAlO₂ to the metals, such as copper and aluminum. In addition, the CuAlO₂ may form film layers on the surfaces of the aluminum nitride particles, and the film layers may play a role as an interfacial layer in the subsequent process of compounding the aluminum nitride ceramic skeleton with the molten metal to further increase the bonding force between the aluminum nitride ceramic skeleton and the metal. The aluminum nitride ceramic skeleton of the present disclosure does not need to or only needs to slightly build an interfacial layer to guarantee the bonding force between the aluminum nitride ceramic skeleton and the metal, thereby obtaining the metal-based aluminum nitride composite material having excellent compounding performance.

Specifically, chemical formulas of the reaction of the aluminum nitride with the cupric oxide or cuprous oxide are as follows:

4AlN+2Cu₂O+3O₂=4CuAlO₂+2N₂↑

2AlN+2CuO+O₂=2CuAlO₂+N₂↑

Optionally, the content of the CuAlO₂ is 5 to 20 percent by weight based on the total amount of the aluminum nitride ceramic skeleton.

On a second aspect, the present disclosure provides a method for fabricating a metal-based aluminum nitride composite material. The method includes:

(1) sequentially mixing, drying, smashing, press-molding, and sintering a raw material containing aluminum nitride particles, copper oxide powder, and a binder to prepare an aluminum nitride ceramic skeleton, wherein the copper oxide powder is cupric oxide powder and/or cuprous oxide powder; and

(2) filling at least part of pores of the aluminum nitride ceramic skeleton with molten metal by a gas pressure infiltration method.

On a third aspect, the present disclosure provides a metal-based aluminum nitride composite material prepared by the above method.

The aluminum nitride ceramic skeleton of the present disclosure forms a multi-porous ceramic structure using an in-situ pore-forming method. Moreover, a CuAlO₂ substance is formed in the aluminum nitride ceramic skeleton prepared by the present disclosure. Because of the better wettability of the CuAlO₂ to the metals such as copper and aluminum, subsequent construction of interfacial layers is reduced during compounding of the aluminum nitride ceramic skeleton with the metal, which is favorable for the subsequent compounding with the metal to prepare the metal-based aluminum nitride composite material. In addition, the CuAlO₂ may be formed on the surfaces of the aluminum nitride particles as the film layers, and the film layers may play a role of an interfacial layer in the subsequent process of compounding the aluminum nitride ceramic skeleton with the molten metal, so that the bonding force between the aluminum nitride ceramic skeleton and the metal may be further increased.

Other features and advantages of the present disclosure are described in detail in the following implementations and embodiments.

### DETAILED DESCRIPTION

Some implementations and embodiments of the present disclosure are described in detail below. It should be understood that the implementations and embodiments described herein are merely used to describe and explain the present disclosure rather than limit the present disclosure.

Endpoints of all ranges and all values disclosed herein are not limited to the precise ranges or values, and these ranges or values should be understood as including values close to these ranges or values. For value ranges, endpoint values of the ranges, the endpoint values of the ranges and individual point values, and the individual point values can be combined with each other to obtain one or more new value ranges. These value ranges should be construed as being specifically disclosed in this specification.

In a first aspect, the present disclosure provides a metal-based aluminum nitride composite material. The composite material includes an aluminum nitride ceramic skeleton and a metal filling at least part of pores of the aluminum nitride ceramic skeleton. The aluminum nitride ceramic skeleton contains aluminum nitride and CuAlO₂, and the aluminum nitride ceramic skeleton has a porosity of 20 to 40 percent.

The inventors of the present disclosure have found that the CuAlO₂ may be generated through the reaction of the aluminum nitride with cupric oxide or cuprous oxide during sintering, and a composite material with excellent bonding force between the aluminum nitride ceramic skeleton and the metal is obtained. The reason may be the better wettability of the CuAlO₂ to the metals such as copper and aluminum. In addition, the CuAlO₂ may form film layers on the surfaces of the aluminum nitride particles, and the film layers may play a role of an interfacial layer in the subsequent process of compounding the aluminum nitride ceramic skeleton with the molten metal, so that the bonding force between the aluminum nitride ceramic skeleton and the metal may be further increased.

In some embodiments, the content of the CuAlO₂ is 5 to 20 percent by weight or 10 to 20 percent by weight based on the total amount of aluminum nitride ceramic, so that the bonding force between the aluminum nitride ceramic skeleton and the metal may be increased.

According to the composite material of the present disclosure, the aluminum nitride ceramic skeleton may also contain a copper oxide, wherein the copper oxide may include the cupric oxide and/or cuprous oxide. Since the cupric oxide and/or cuprous oxide may not react completely, the aluminum nitride ceramic skeleton of the present disclosure may inevitably contain the cupric oxide and/or cuprous oxide. In an implementation of the present disclosure, the content of the copper oxide may be 0 to 3 percent by weight, for example, 0.1 to 1 percent by weight, based on the total amount of the aluminum nitride ceramic.

According to the composite material of the present disclosure, in some embodiments, the aluminum nitride ceramic skeleton may further contain MnO₂, MnO, and Al₂O₃. Since the aluminum nitride ceramic contains the MnO₂, the MnO, and the Al₂O₃, the bonding force between the aluminum nitride ceramic and the metal may be improved. In some embodiments, based on the total amount of the aluminum nitride ceramic, the content of the MnO₂ is 0 to 3 percent by weight (for example, 1 to 2 percent by weight), the content of the MnO is 0 to 3 percent by weight (for example, 1 to 2 percent by weight), and the content of the A₂O₃ is 0 to 5 percent by weight (for example, 2 to 4 percent by weight).

According to the composite material of the present disclosure, in some embodiments, the aluminum nitride ceramic skeleton further contains Y₂O₃ and YAlO₃, so that the temperature of ceramic sintering molding may be reduced. In some embodiments, based on the total amount of the aluminum nitride ceramic skeleton, the content of the Y₂O₃ is 1 to 5 percent by weight (for example, 1 to 3 percent by weight), and the content of the YAlO₃ is 1 to 10 percent by weight (for example, 3 to 5 percent by weight).

In an embodiment of the present disclosure, the aluminum nitride ceramic skeleton may contain aluminum nitride, CuAlO₂, cupric oxide, and/or cuprous oxide, MnO₂, MnO, Al₂O₃, Y₂O₃, YAlO₃, and carbon, to improve the bending strength of the aluminum nitride ceramic skeleton and the bondability between the aluminum nitride ceramic skeleton and the metal. In some embodiments, based on the total weight of the aluminum nitride ceramic skeleton, the content of the aluminum nitride is 70 to 90 percent by weight, the content of the CuAlO₂ is 5 to 20 percent by weight, the content of the cupric oxide is 0 to 1 percent by weight, the content of the cuprous oxide is 0 to 1 percent by weight, the content of the MnO₂ is 0 to 2 percent by weight, the content of the MnO is 0 to 2 percent by weight, the content of the Al₂O₃ is 1 to 5 percent by weight, the content of the Y₂O₃ is 1 to 3 percent by weight, the content of the YAlO₃ is 3 to 5 percent by weight, and the balance is the carbon. In some embodiments, based on the total weight of the aluminum nitride ceramic skeleton, the content of the aluminum nitride is 80 to 90 percent by weight, the content of the CuAlO₂ is 5 to 15 percent by weight, the content of the cupric oxide is 0.05 to 0.5 percent by weight, the content of the cuprous oxide is 0.05 to 0.5 percent by weight, the content of the MnO₂ is 1 to 1.5 percent by weight, the content of the MnO is 1 to 1.5 percent by weight, the content of the Al₂O₃ is 2 to 4 percent by weight, the content of the Y₂O₃ is 1 to 2 percent by weight, the content of the YAlO₃ is 3 to 4 percent by weight, and the balance is the carbon, so that the bending strength of the aluminum nitride ceramic skeleton and the bondability between the aluminum nitride ceramic skeleton and the metal may be further improved to obtain a composite material having improved compounding performance of the metal and aluminum nitride ceramic skeleton.

According to the composite material of the present disclosure, the aluminum nitride ceramic skeleton may have a density of 1.96 to 2.59 g/cm³.

According to the composite material of the present disclosure, the aluminum nitride ceramic skeleton may inevitably contain the carbon due to the addition of the binder, but the content of the carbon may be negligible and not affect the performance of the aluminum nitride ceramic skeleton.

The contents of the various components of the aluminum nitride ceramic skeleton of the present disclosure may be measured by various conventional methods. For example, an XRD (X-Ray Diffraction) phase test method may be employed.

According to the composite material of the present disclosure, the metal may be various conventional metals in the art, for example, one or more of aluminum, an aluminum alloy, copper, and a copper alloy. In the present disclosure, the aluminum alloy may be various types of aluminum alloys in the art, for example, at least one of an aluminum silicon alloy, an aluminum magnesium alloy, an aluminum titanium alloy, and an aluminum zirconium alloy. The copper alloy may be various types in the art, for example, at least one of red copper, brass, and white copper.

According to the composite material of the present disclosure, in the embodiments of the present disclosure, the content of the aluminum nitride ceramic skeleton may be 60 to 80 percent by volume or 65 to 75 percent by volume, based on the total volume of the composite material, so that the bondability between the aluminum nitride ceramic skeleton and the metal may be improved.

According to the composite material of the present disclosure, in an embodiment of the present disclosure, the aluminum nitride ceramic skeleton further includes a zirconium oxide and/or manganese oxide attached to the surfaces of at least part of pores of the aluminum nitride ceramic skeleton. Zirconium oxide and/or manganese oxide interfacial layers may be slightly formed on the surfaces of at least part of the pores of the aluminum nitride ceramic skeleton, such as thin interfacial layers, so that the bonding force between the aluminum nitride ceramic skeleton and the metal may be further increased. In some embodiments, the weight ratio of the aluminum nitride ceramic skeleton to the zirconium oxide and/or manganese oxide is 1:(0 to 0.05) or 1:(0 to 0.03), for example 1:(0.01 to 0.02), so that the bonding force between the aluminum nitride ceramic skeleton and the metal may be further increased.

In a second aspect, the present disclosure provides a method for preparing a metal-based aluminum nitride composite material. The method includes:

(1) sequentially mixing, drying, smashing, press-molding, and sintering a raw material containing aluminum nitride particles, copper oxide powder, and a binder to fabricate an aluminum nitride ceramic skeleton, wherein the copper oxide powder is cupric oxide powder and/or cuprous oxide powder; and

(2) filling at least part of pores of the aluminum nitride ceramic skeleton with molten metal by a gas pressure infiltration method.

The method of the present disclosure can form CuAlO₂ in the aluminum nitride ceramic skeleton, so that the bonding force between the metal and the aluminum nitride ceramic skeleton in the composite material may be increased. The reason may be the better wettability of the CuAlO₂ to the metals such as copper and aluminum. In addition, the CuAlO₂ may form film layers on the surfaces of the aluminum nitride particles, so that the bonding force between the metal and the aluminum nitride ceramic skeleton may be further increased.

In the method of the present disclosure, during the sintering, the decomposition of the cupric oxide may release oxygen, which contributes to the formation of the pores.

According to the method of the present disclosure, in some embodiments, in step (1), the raw material may further contain a manganese source, and the manganese source may be, for example, manganese salt. In some embodiments, the manganese salt may be manganese nitrate and/or manganese silicate. For example, the manganese salt is the manganese nitrate. In this embodiment, the manganese nitrate may be decomposed into oxygen, nitric oxide gas, and MnO₂ during the sintering, while the MnO₂ may react with the aluminum nitride to produce alumina, MnO, and nitrogen. The production of the gas may significantly improve the porosity of the aluminum nitride ceramic skeleton, thereby improving the bondability between the aluminum nitride ceramic skeleton and the metal. The reaction formula of the MnO₂ and the aluminum nitride is as follows:

2AlN+3MnO₂=Al₂O₃+3MnO+N₂↑

According to the method of the present disclosure, in some embodiments, in step (1), the raw material may further contain an yttrium source. In some embodiments, the yttrium source may include yttrium oxide, and the addition of the yttrium oxide may reduce the sintering temperature and increase the toughness and strength of an aluminum nitride ceramic plate.

In an embodiment of the present disclosure, in step (1), the raw material may contain aluminum nitride powder, cupric oxide powder, and/or cuprous oxide powder, yttrium oxide, manganese silicate, manganese nitrate, and a binder, so that the bending strength of the aluminum nitride ceramic and the bondability between the aluminum nitride ceramic and the metal may be improved. In some embodiments, based on the total weight of the raw material, the usage amount of the aluminum nitride particles is 70 to 90 percent by weight, the usage amount of the yttrium oxide is 2 to 10 percent by weight, the usage amount of the cupric oxide powder is 0 to 10 percent by weight, the usage amount of the cuprous oxide powder is 0 to 10 percent by weight, the usage amount of the manganese nitrate is 0 to10 percent by weight, the balance is the binder by dry weight, and the contents of the cupric oxide powder and the cuprous oxide powder are not 0 at the same time. In some embodiments, based on the total weight of the raw material, the usage amount of the aluminum nitride particles is 80 to 90 percent by weight, the usage amount of the yttrium oxide is 5 to 8 percent by weight, the usage amount of the cupric oxide powder is 5 to 10 percent by weight, the usage amount of the cuprous oxide powder is 5 to 10 percent by weight, the usage amount of the manganese nitrate is 3 to 6 percent by weight, and the balance is the binder by dry weight, so that the bending strength of the aluminum nitride ceramic skeleton and the bondability between the aluminum nitride ceramic skeleton and the metal may be further improved.

According to the method of the present disclosure, in step (1), the aluminum nitride particles may be various conventional aluminum nitride particles in the art. In some embodiments, the aluminum nitride particles may have a particle size of 5 to 200 μm or 30 to 150 μm, or, 50 to 100 μm, so that the bondability between the obtained aluminum nitride ceramic skeleton and the metal may be improved.

According to the method of the present disclosure, in step (1), the copper oxide powder may be various conventional copper oxide powders in the art, and the particle size of the copper oxide powder may be, for example, 5 to 50 μm.

According to the method of the present disclosure, in step (1), the binder may be various conventional binders in the art, for example, at least one of a polyvinyl alcohol (PVA) aqueous solution, a polyvinyl butyral (PVB) alcoholic solution and epoxy resin, and the PVA aqueous solution. In some embodiments, the concentration of the PVA aqueous solution is 5 to 20 percent by weight, or, 8 to 12 percent by weight, so that the strength and formability of the molded skeleton may be improved, and the skeleton is not liable to break and convenient to carry.

According to the method of the present disclosure, in step (1), the mixing may be performed using a conventional kneader, and the mixing time is not particularly limited as long as the various components in the raw material are uniformly mixed. For example, the mixing time may be 1.5 to 5 hours. In an embodiment of the present disclosure, the solid components may be firstly mixed for 0.5 to 2 hours, and then the binder solution is added and mixed for 1 to 3 hours.

According to the method of the present disclosure, in step (1), the drying may be various conventional modes under various conventional drying conditions in the art, for example, the drying is performed in an oven at 60 to 80° C. for 0.5 to 1.5 hours.

According to the method of the present disclosure, in some embodiments, step (1) also includes a sieving step after the smashing and before the pressing. A sieve for sieving has a sieve pore of 50 to 300 meshes, for example 80 to 100 meshes.

According to the method of the present disclosure, in step (1), the press-molding mode may be various mechanical pressing methods for press-molding in the art. Conditions for press-molding may include maintaining a pressure of 30 to 50 kg/cm² for 20 to 30 s. A mold of press-molding may include various specifications, for example, a square mold.

According to the method of the present disclosure, in some embodiments, in step (1), the sintering temperature control program includes: heating from a room temperature to 150 to 350° C., maintaining the temperature for 1 to 3 hours, then heating to 1,000 to 1,300° C., and maintaining the temperature for 2 to 5 hours. In some embodiments, the program may include heating from the room temperature to 180 to 300° C., maintaining the temperature for 1.5 to 3 hours, and then heating to 1,050 to 1,200° C., and maintaining the temperature for 2 to 5 hours. In some embodiments, the program may include heating from the room temperature to 200 to 300° C., maintaining the temperature for 2 to 3 hours, then heating to 1,050 to 1,150° C., and maintaining the temperature for 2 to 3 hours. Therefore, the prepared aluminum nitride ceramic skeleton may have a better bending strength and a higher metal bonding force.

In the implementation of the present disclosure, in step (1), the temperature increase rate in the heating is 2 to 10° C./minute or 2 to 7° C./minute, or, 3 to 5° C./minute, so that the prepared aluminum nitride ceramic skeleton may have a better bending strength and a higher metal bonding force.

According to the method of the present disclosure, in the implementations of the present disclosure, in step (1), the sintering is performed under a nitrogen and oxygen atmosphere provided by mixed gas containing nitrogen and oxygen. The oxygen content of the mixed gas is 1 to 15 percent by volume or 5 to 10 percent by volume. If the oxygen content is too low, it may not satisfy the reaction of the aluminum nitride with the cupric oxide or cuprous oxide. If the oxygen content is too high, excessive alumina is produced, which reduces the purity of the aluminum nitride ceramic skeleton and reduces the heat dissipation property, strength, and tolerance of the aluminum nitride ceramic skeleton.

According to the method of the present disclosure, in the implementations of the present disclosure, in step (1), the raw material does not contain a pore former, wherein the pore former includes starch, stearic acid, and carbon powder. In some embodiments, the pore former is the carbon powder. That is, when the raw material of the present disclosure does not contain the pore former carbon powder, pore former residues may be avoided, the interfacial layer performance may be improved, and the CuAlO₂ having better wettability to the copper and the aluminum may be formed.

According to the method of the present disclosure, the method further includes that: the aluminum nitride ceramic skeleton obtained in step (1) may be immersed in a nitrate solution, then dried, and calcined in an inert atmosphere, so that a zirconium oxide and/or manganese oxide may be formed on the surfaces of at least part of the pores of the aluminum nitride ceramic skeleton. That is, zirconium oxide and/or manganese oxide interfacial layers may be slightly formed on the surfaces of at least part of the pores of the aluminum nitride ceramic skeleton (e.g., thin zirconium oxide and/or manganese oxide interfacial layers), so that the bonding force between the aluminum nitride ceramic skeleton and the metal may be further increased. The nitrate may be manganese nitrate and/or zirconium nitrate. In some embodiments, the concentration of the nitrate solution is 0.001 to 0.1 mol/L. In this implementation, the drying temperature may be 60 to 350° C. or 100 to 300° C., and the calcining temperature may be 500 to 1,200° C. or 600 to 1,000° C.

In the present disclosure, the inert atmosphere may be provided by nitrogen or rare gas (such as at least one of helium, neon, argon, krypton, and xenon.)

According to the method of the present disclosure, in step (2), the metal may be various conventional metals in the art, for example, one or more of aluminum, an aluminum alloy, copper, and a copper alloy. In the present disclosure, the aluminum alloy may be various types of aluminum alloys in the art, for example, at least one of an aluminum silicon alloy, an aluminum magnesium alloy, an aluminum titanium alloy, and an aluminum zirconium alloy. The copper alloy may be various types of copper alloys in the art, for example, at least one of red copper, brass, and white copper.

According to the method of the present disclosure, in an implementation of the present disclosure, the content of the aluminum nitride ceramic skeleton may be 60 to 80 percent by volume or 65 to 75 percent by volume, based on the total volume of the obtained composite material, so that the bonding force between the aluminum nitride skeleton and the metal may be increased.

According to the method of the present disclosure, in step (2), the gas pressure infiltration method may be various conventional gas pressure infiltration methods in the art. For example, this method may include that, the aluminum nitride ceramic skeleton is put into a mold, and the mold is placed in an infiltration apparatus furnace chamber and preheated. The molten metal is poured into the mold, which is maintained at an elevated temperature. The chamber is vacuumed, fed with nitrogen to reach a specified pressure, and cooled. During the process, the mold is preheated to 500 to 700° C., the elevated temperature may be kept at 650 to 800° C., and the specified pressure may be 4 to 10 MPa. The pressure of the present disclosure refers to a gauge pressure. The infiltration apparatus furnace chamber of the present disclosure may be various conventional impregnation apparatus furnace chambers in the art.

In a third aspect, the present disclosure provides a metal-based aluminum nitride composite material produced by the above method.

An aluminum nitride ceramic skeleton in the metal-based aluminum nitride composite material prepared by the present disclosure may have a density of 1.96 to 2.59 g/cm³, a porosity of 20 to 40 percent, and a bending strength of 10 to 40 MPa. A bonding force between the aluminum nitride ceramic skeleton and the metal may be as high as 8 to 15 N/mm. The composite material may have the bending strength as high as 330 to 460 MPa and the thermal conductivity as high as 100 to 160 W/(mK).

The embodiments of the present disclosure are described in detail below.

Preparation example 1

The raw material of the aluminum nitride ceramic skeleton included, based on the total weight of the raw material, 80 percent by weight of the aluminum nitride powder, 5 percent by weight of the yttrium oxide, 10 percent by weight of the cuprous oxide powder, 4 percent by weight of the manganese nitrate, and 10 percent by weight of the PVA aqueous solution having a PVA content of 10 percent by weight. The aluminum nitride powder had a particle size of 90 μm, and the cuprous oxide powder had a particle size of 15 μm.

The solid components in the raw material of the above aluminum nitride ceramic skeleton were mixed in a kneader for 0.5 h (hours), and then the binder PVA aqueous solution was added for continuous mixing for 1 h The mixture was transferred to an oven and dried at 70° C. for 1.0 h, and smashed and sieved with a sieve having a sieve pore of 80 meshes. The siftages were put into a 60 mm*60 mm square mold, and was pressed under a pressure of 30 kg/cm² for 20 seconds to obtain a 60 mm*60 mm square sheet. The square sheet was sintered under a nitrogen and oxygen atmosphere having an oxygen content of 5 percent by volume to obtain an aluminum nitride ceramic skeleton Al. A sintering temperature control program was to heat from a room temperature to 300° C. at a temperature increase rate of 3° C./minute, maintain the temperature for 2 h, then heat to 1,100° C. at the temperature increase rate of 3° C./minute and maintain the temperature for 2.5 h.

Preparation example 2

The raw material of the aluminum nitride ceramic skeleton included, based on the total weight of the raw material, 84 percent by weight of the aluminum nitride powder, 7 percent by weight of the yttrium oxide, 6 percent by weight of the cupric oxide powder, 2 percent by weight of the manganese nitrate, and 10 percent by weight of the PVA aqueous solution having a PVA content of 10 percent by weight, wherein the aluminum nitride powder had a particle size of 90 μm, and the cuprous oxide powder had a particle size of 15 μm.

The solid components in the raw material of the above aluminum nitride ceramic skeleton were mixed in a kneader for 0.5 h, and then the binder PVA aqueous solution was added for continuous mixing for 1 h. The mixture was transferred to an oven and dried at 80° C. for 0.5 h, and smashed and sieved with a sieve having a sieve pore of 90 meshes. The siftages were put into a 60 mm*60 mm square mold, and pressed under a pressure of 40 kg/cm² for 30 s to obtain a 60 mm*60 mm square sheet. The square sheet was sintered under a nitrogen and oxygen atmosphere having an oxygen content of 10 percent by volume to obtain an aluminum nitride ceramic skeleton A2. A sintering temperature control program was to heat from a room temperature to 200° C. at a temperature increase rate of 4° C./minute, maintain the temperature for 3 h, then heat to 1,050° C. at the temperature increase rate of 5° C./minute and maintain the temperature for 3 h.

Preparation example 3

The raw material of the aluminum nitride ceramic skeleton included, based on the total weight of the raw material, 80 percent by weight of the aluminum nitride powder, 5 percent by weight of the yttrium oxide, 5 percent by weight of the cuprous oxide powder, 5 percent by weight of the cupric oxide powder, 3.8 percent by weight of the manganese nitrate, and 15 percent by weight of the PVA aqueous solution having a PVA content of 8 percent by weight, wherein the aluminum nitride powder had a particle size of 90 μm, the cuprous oxide powder had a particle size of 15 μm, and the cupric oxide powder had a particle size of 30 μm.

The solid components in the raw material of the above aluminum nitride ceramic skeleton were mixed in a kneader for 1 h, and then the binder PVA aqueous solution was added for continuous mixing for 2 h. The mixture was transferred to an oven and dried at 60° C. for 1.5 h, and smashed and sieved with a sieve having a sieve pore of 90 meshes. The siftages were put into a 60 mm*60 mm square mold, and pressed under a pressure of 50 kg/cm² for 25 s to obtain a 60 mm*60 mm square sheet. The square sheet was sintered under a nitrogen and oxygen atmosphere having an oxygen content of 15 percent by volume to obtain an aluminum nitride ceramic skeleton A3. A sintering temperature control program was to heat from a room temperature to 260° C. at a temperature increase rate of 5° C./minute, maintain the temperature for 2.5 h, then heat to 1,150° C. at the temperature increase rate of 4° C./minute and maintain the temperature for 2 h.

Preparation example 4

An aluminum nitride ceramic skeleton was prepared according to the method of the preparation example 1. The difference was that the raw material of the aluminum nitride ceramic skeleton included, based on the total weight of the raw material, 73.5 percent by weight of the aluminum nitride powder, 4 percent by weight of the yttrium oxide, 15 percent by weight of the cuprous oxide powder, 6 percent by weight of the manganese nitrate, and 15 percent by weight of the PVA aqueous solution having a PVA content of 10 percent by weight, to obtain an aluminum nitride ceramic skeleton A4.

Preparation example 5

An aluminum nitride ceramic skeleton was prepared according to the method of the preparation example 1. The difference was that based on the total weight of the raw material, the usage amount of the cuprous oxide powder was 2 percent by weight, so that the content of the CuAlO₂ in a prepared aluminum nitride ceramic skeleton A5 was 2.73 percent by weight.

Preparation example 6

An aluminum nitride ceramic skeleton was prepared according to the method of the preparation example 1. The difference was that the raw material did not contain the manganese nitrate, and the manganese nitrate was replaced with an equivalent amount of aluminum nitride powder, to obtain an aluminum nitride ceramic skeleton A6.

Preparation example 7

An aluminum nitride ceramic skeleton was prepared according to the method of the preparation example 1. The difference was that the raw material did not contain the yttrium oxide, and the yttrium oxide was replaced with an equivalent amount of aluminum nitride powder, to obtain an aluminum nitride ceramic skeleton A7.

Preparation example 8

An aluminum nitride ceramic skeleton was prepared according to the method of the preparation example 1. The difference was that based on the total weight of the raw material, the usage amount of the yttrium oxide was 3 percent by weight, so that the content of Y₂O₃ in a prepared aluminum nitride ceramic skeleton A8 was 0.61 percent by weight, and the content of YAlO₃ was 2.73 percent by weight.

Preparation example 9

An aluminum nitride ceramic skeleton was prepared according to the method of the preparation example 1. The difference was that the aluminum nitride powder had a particle size of 120 to obtain an aluminum nitride ceramic skeleton A9.

Preparation example 10

An aluminum nitride ceramic skeleton was prepared according to the method of the preparation example 1. The difference was that the sintering temperature control program was to heat from a room temperature to 180° C. at a temperature increase rate of 6° C./minute and maintain the temperature for 2 h, and then heat to 1,160° C. at the temperature increase rate of 6° C./minute and maintain the temperature for 3.5 h, to obtain an aluminum nitride ceramic skeleton A10.

Preparation example 11

An aluminum nitride ceramic skeleton was prepared according to the method of the preparation example 1. The difference was that the sintering temperature control program was to heat from a room temperature to 160° C. at a temperature increase rate of 2° C./minute, maintain the temperature for 1 h, then heat to 1,250° C. at the temperature increase rate of 2° C./minute and maintain the temperature for 2 h, to obtain an aluminum nitride ceramic skeleton A11.

Preparation comparison example 1

An aluminum nitride ceramic skeleton was prepared according to the method of the preparation example 1. The difference was that the raw material did not contain the cuprous oxide powder and the manganese nitrate, and the cuprous oxide powder and the manganese nitrate were replaced with an equivalent amount of aluminum nitride powder, to obtain an aluminum nitride ceramic skeleton D1.

Preparation comparison example 2

An aluminum nitride ceramic skeleton was prepared according to the method of the preparation example 1. The difference was that the raw material did not contain the cuprous oxide powder, and the cuprous oxide powder was replaced with an equivalent amount of aluminum nitride powder, to obtain an aluminum nitride ceramic skeleton D2.

Preparation comparison example 3

An aluminum nitride ceramic skeleton was prepared according to the method of the preparation example 2. The difference was that the raw material did not contain the cupric oxide powder, and the cupric oxide powder was replaced with an equivalent amount of aluminum nitride powder, to obtain an aluminum nitride ceramic skeleton D3.

Preparation comparison example 4

An aluminum nitride ceramic skeleton was prepared according to the method of the preparation example 3. The difference was that the raw material did not contain the cupric oxide powder and the cuprous oxide powder, and the cupric oxide powder and the cuprous oxide powder were replaced with an equivalent amount of aluminum nitride powder, to prepare an aluminum nitride ceramic skeleton D4.

### Embodiment 1

The present embodiment was used for describing the metal-based aluminum nitride composite material and the fabrication method thereof of the present disclosure.

(1) The aluminum nitride ceramic skeleton A1 obtained in the preparation example 1 was immersed in a manganese nitrate solution at a concentration of 0.04 mol/L, then was dried at 100° C. and was calcined at 600° C. under a nitrogen atmosphere, wherein a weight ratio of the aluminum nitride ceramic skeleton A1 to manganese oxide was 1:0.01.

(2) The aluminum nitride ceramic skeleton obtained in step (1) was put into a mold, and the mold was placed into an infiltration apparatus furnace chamber and preheated to 600° C. Then molten aluminum was poured into the mold, which is maintained at 700° C. The chamber was vacuumed, and then fed with nitrogen to a pressure of 8 MPa. After cooling, the product was taken out from the mold to obtain a metal-based aluminum nitride composite material B1. A drainage method was used to measure the content of the aluminum nitride ceramic skeleton to be 65 percent by volume based on the total volume of the composite material.

### Embodiment 2

The present embodiment was used for describing the metal-based aluminum nitride composite material of the present disclosure and the fabrication method thereof.

(1) The aluminum nitride ceramic skeleton A2 obtained in the preparation example 2 was immersed in a zirconium nitrate solution at a concentration of 0.04 mol/L, then was dried at 200° C., and was calcined at 800° C. under a nitrogen atmosphere, wherein a weight ratio of the aluminum nitride ceramic skeleton A2 to zirconium oxide was 1:0.01.

(2) The aluminum nitride ceramic skeleton obtained in step (1) was put into a mold, and the mold was placed into an infiltration apparatus furnace chamber and preheated to 600° C. Then molten aluminum was poured into the mold, which is maintained at 700° C. The chamber was vacuumed and then fed with nitrogen to a pressure of 8 MPa. After cooling, the product was taken out from the mold to obtain a metal-based aluminum nitride composite material B2. A drainage method was used to measure the content of the aluminum nitride ceramic skeleton to be 67 percent by volume based on the total volume of the composite material.

### Embodiment 3

The present embodiment was used for describing the metal-based aluminum nitride composite material of the present disclosure and the fabrication method thereof.

(1) The aluminum nitride ceramic skeleton A3 obtained in the preparation example 3 was immersed in a 0.06 mol/L manganese nitrate solution, then was dried at 300° C., and was calcined at 1,000° C. under a nitrogen atmosphere, wherein a weight ratio of the aluminum nitride ceramic skeleton A3 to manganese oxide was 1:0.015.

(2) The aluminum nitride ceramic skeleton obtained in step (1) was put into a mold, and the mold was placed into an infiltration apparatus furnace chamber and preheated to 600° C. Then molten copper was poured into the mold, which is maintained at 700° C. The chamber was vacuumed and then fed with nitrogen to a pressure of 5 MPa. After cooling, the product was taken out from the mold to obtain a metal-based aluminum nitride composite material B3. A drainage method was used to measure the content of the aluminum nitride ceramic skeleton to be 70 percent by volume based on the total volume of the composite material.

### Embodiments 4 to 11

The present embodiments were used for describing the metal-based aluminum nitride composite material of the present disclosure and the fabrication method thereof.

The aluminum nitride ceramic skeletons A4 to A11 obtained in the preparation examples 4 to 11 were respectively prepared into metal-based aluminum nitride composite materials B4 to B11 by the method of Embodiment 1.

### Embodiment 12

The present embodiment was used for describing the metal-based aluminum nitride composite material of the present disclosure and the fabrication method thereof.

The metal-based aluminum nitride composite material was prepared according to the method of Embodiment 1. The difference was that step (1) was omitted, and the aluminum nitride ceramic skeleton obtained in the preparation example 1 was directly subjected to gas pressure infiltration, to obtain a metal-based aluminum nitride composite material B12.

### Embodiment 13

The present embodiment was used for describing the metal-based aluminum nitride composite material of the present disclosure and the fabrication method thereof.

The metal-based aluminum nitride composite material was prepared according to the method of Embodiment 1. The difference was that the content of the aluminum nitride ceramic skeleton in the obtained metal-based aluminum nitride composite material B13 was 60 percent by volume.

### Embodiment 14

The present embodiment was used for describing the metal-based aluminum nitride composite material of the present disclosure and the fabrication method thereof.

The metal-based aluminum nitride composite material was prepared according to the method of Embodiment 1. The difference was that the molten aluminum in step (2) was replaced with a magnesium alloy, to obtain a metal-based aluminum nitride composite material B14.

### COMPARISON EXAMPLES 1 TO 4

The present comparison examples were used for describing the comparison metal-based aluminum nitride composite material and the fabrication method thereof.

The aluminum nitride ceramic skeletons D1 to D4 obtained in the preparation comparison examples 1 to 4 were respectively prepared into metal-based aluminum nitride composite materials DB1 to DB4 by the method of Embodiment 1.

### COMPARISON EXAMPLE 5

The present comparison example was used for describing the comparison metal-based aluminum nitride composite material and the fabrication method thereof.

The metal-based aluminum nitride composite material was prepared according to the method of Embodiment 1. The difference was that the molten aluminum infiltrated the aluminum nitride ceramic skeleton by a method in the patent application CN102815957A, to obtain a metal-based aluminum nitride composite material DB5.

Test Case 1

Porosities and densities of the aluminum nitride ceramic skeletons A1 to A11 and D1 to D4 obtained in the preparation examples 1 to 11 and the preparation comparison examples 1 to 4 were measured according to GB/T 25995-2010. The method included that, the aluminum nitride ceramic skeletons were immersed in molten paraffin liquid for 0.5 hour by using the Archimedes principle to cause paraffin to fully fill pores in the aluminum nitride ceramic skeletons. Then the aluminum nitride ceramic skeletons were taken out, and the volumes of the aluminum nitride ceramic skeletons were measured by the drainage method. The densities and the porosities of the aluminum nitride ceramic skeletons were calculated. Results are shown in Table 1 below.

Test Case 2

The bending strengths of the aluminum nitride ceramic skeletons A1 to A11 and D1 to D4 obtained in the preparation examples 1 to 11 and the preparation comparison examples 1 to 4 were measured according to GB/T 1451-2005. The measurement method included that, the aluminum nitride ceramic skeletons obtained by sintering were cut into test sample strips having length*width*height of 50*10*4 mm using a cutting machine EC-400 and a GJ-1166A type 500 kg universal tester having test parameters of a span 30 mm and a pressing speed 0.5 mm/minute. Measured results are shown in Table 1 below.

Test Case 3

The aluminum nitride ceramic skeletons A1 to A4 obtained in the preparation examples 1 to 4 and the aluminum nitride ceramic skeleton D1 obtained in the preparation comparison example 1 were subjected to XRD phase measurement according to JY/T 009-1996. Results are shown in Table 2 below.

Test Case 4

The bonding forces of metal and aluminum nitride ceramic skeleton of the metal-based aluminum nitride composite materials B1 to B14 obtained by the above embodiments and the metal-based aluminum nitride composite materials DB1 to DB5 obtained by the comparison examples were tested. A measurement method was to test their peel strengths. Measured results are shown in Table 3 below.

The measurement method included that: (1) a copper or aluminum layer on the surfaces of an aluminum nitride and aluminum composite material (DBA) and an aluminum nitride and copper composite material (DBC) which were obtained by the test case were etched into strips having a size of 80 mm×5 mm by using a chemical etching method; (2) test samples obtained by etching were fixed on a test fixture, and the universal tester was used to peel off the copper strips or aluminum strips from the surface of the composite material in a perpendicular direction, and a measured minimum peel force Fₘᵢₙ and average peel force F_{average} were read from a computer; (3) the width d of the peeled copper strips or aluminum strips was measured with a caliper; and (4) the corresponding peel strength was calculated according to the following formula, wherein test conditions were as follows: the temperature was 15 to 25° C., and the humidity was 50 to 60 percent.

Peel strength (N/mm)=minimum peel force (N)/test sample strip width (mm)

Test Case 5

The bending strengths of the metal-based aluminum nitride composite materials B1 to B14 prepared by the above embodiments and the metal-based aluminum nitride composite materials DB1 to DB5 prepared by the comparison examples were measured according to YB/T 5349-2014. Measured results are shown in Table 3 below.

Test Case 6

The thermal conductivities of the metal-based aluminum nitride composite materials B1 to B14 prepared by the above embodiments and the metal-based aluminum nitride composite materials DB1 to DB5 prepared by the comparison examples were measured according to ASTM E1461. Measured results are shown in Table 3 below.

TABLE 1

| | Density | Porosity | Bending |
|---|---|---|---|
| | of | of | strength of |
| | aluminum | aluminum | aluminum |
| | nitride | nitride | nitride |
| | ceramic | ceramic | ceramic |
| | skeleton | skeleton | skeleton |
| Number | (g/cm³) | (%) | (MPa) |
| Preparation example 1 | 2.1683 | 34.4877 | 26.6283 |
| Preparation example 2 | 2.1749 | 33.2853 | 30.0248 |
| Preparation example 3 | 2.3864 | 26.7964 | 35.1363 |
| Preparation example 4 | 1.9603 | 39.8681 | 27.8429 |
| Preparation example 5 | 2.5893 | 20.5736 | 12.1354 |
| Preparation example 6 | 2.3102 | 29.1342 | 15.3145 |
| Preparation example 7 | 2.1724 | 33.3624 | 10.3951 |
| Preparation example 8 | 2.1499 | 34.0524 | 17.8316 |
| Preparation example 9 | 2.2509 | 30.9546 | 20.3418 |
| Preparation example 10 | 2.3095 | 29.1576 | 10.1839 |
| Preparation example 11 | 2.2538 | 30.8657 | 12.5942 |
| Preparation comparison | 2.8246 | 13.3558 | 3.7622 |
| example 1 | | | |
| Preparation comparison | 2.7992 | 14.1352 | 3.8161 |
| example 2 | | | |
| Preparation comparison | 2.8282 | 13.2443 | 3.7933 |
| example 3 | | | |
| Preparation comparison | 2.7987 | 14.1511 | 3.8115 |
| example 4 | | | |

TABLE 2

| Component | | | | | |
|---|---|---|---|---|---|
| of aluminum | | Prep- | Prep- | Prep- | Preparation |
| nitride | | aration | aration | aration | comparison |
| ceramic | Preparation | example | example | example | example |
| skeleton | example 1 | 2 | 3 | 4 | 1 |
| AlN | 75.2 | 79.17 | 73.1 | 68.4 | 92.71 |
| Al₂O₃ | 2.64 | 2.78 | 3.19 | 2.58 | 0.83 |
| Y₂O₃ | 1.28 | 1.83 | 1.35 | 1.16 | 1.76 |
| YAlO₃ | 3.6 | 4.72 | 3.62 | 3.45 | 4.7 |
| CuAlO₂ | 14.28 | 10.09 | 15.76 | 19.91 | / |
| CuO | 0.22 | 0.11 | 0.28 | 0.38 | / |
| Cu₂O | 0.32 | 0.06 | 0.25 | 0.49 | / |
| MnO₂ | 1.26 | 0.65 | 1.19 | 1.87 | / |
| MnO | 1.2 | 0.59 | 1.26 | 1.76 | / |

TABLE 3

| | Bending | Thermal | Bonding strength |
|---|---|---|---|
| | strength | conductivity | between aluminum |
| | of composite | of composite | nitride ceramic |
| | material | material | skeleton and metal |
| Number | (MPa) | (W/(m · K)) | (MPa) |
| Embodiment 1 | 412 | 121 | 13.79 |
| Embodiment 2 | 402 | 130 | 13.61 |
| Embodiment 3 | 458 | 158 | 12.96 |
| Embodiment 4 | 334 | 129 | 14.15 |
| Embodiment 5 | 397 | 108 | 8.76 |
| Embodiment 6 | 380 | 110 | 11.56 |
| Embodiment 7 | 406 | 103 | 8.25 |
| Embodiment 8 | 396 | 105 | 11.93 |
| Embodiment 9 | 378 | 113 | 12.03 |
| Embodiment 10 | 365 | 110 | 11.34 |
| Embodiment 11 | 396 | 109 | 10.35 |
| Embodiment 12 | 359 | 118 | 10.66 |
| Embodiment 13 | 372 | 107 | 10.66 |
| Embodiment 14 | 348 | 101 | 8.20 |
| Comparison example 1 | 318 | 98 | 1.50 |
| Comparison example 2 | 307 | 95 | 1.35 |
| Comparison example 3 | 334 | 98 | 1.43 |
| Comparison example 4 | 326 | 93 | 1.37 |
| Comparison example 5 | 315 | 95 | 1.45 |

It can be seen from the data in Table 1 that the aluminum nitride ceramic skeleton in the composite material obtained in the present disclosure may have the density of 1.96 to 2.59 g/cm³, the porosity of 20 to 40 percent, and the bending strength of 10 to 40 MPa. It can be seen from the data in Table 3 that the bonding force between the aluminum nitride ceramic skeleton and the metal may be as high as 8 to 15 N/mm. The composite material may have the bending strength as high as 330 to 460 MPa and the thermal conductivity as high as 100 to 160 W/(m·K). That is, in the embodiments of the present disclosure, the aluminum nitride ceramic skeleton may have higher porosity and bending strength, thereby obtaining the metal-based aluminum nitride composite material having improved compounding performance. In addition, it can be seen from the data in Table 2 that, the CuAlO₂ substance is formed in the aluminum nitride ceramic skeleton obtained in the embodiments of the present disclosure.

The aluminum nitride ceramic skeleton of the present disclosure forms a multi-porous ceramic structure using an in-situ pore-forming method. Moreover, since the CuAlO₂ with better wettability to the metal copper and aluminum is formed, the formation of the interfacial layers for the subsequent aluminum nitride ceramic skeleton and metal compounding is reduced, which is favorable for the subsequent compounding with the metal to fabricate the metal-based aluminum nitride composite material. In addition, the CuAlO₂ may form the film layers on the surfaces of the aluminum nitride particles, and the film layers may play a role as an interfacial layer in the subsequent process of compounding the aluminum nitride ceramic skeleton with the molten metal, so that the bonding force between the aluminum nitride ceramic skeleton and the metal may be further increased.

The implementations of the disclosure are described in detail above. However, the disclosure is not limited to specific details in the foregoing implementations. Within the scope of the technical idea of the disclosure, a plurality of variances may be performed on the technical solutions of the disclosure, and these variances shall all fall within the protection scope of the disclosure.

It should be further noted that the technical features described in the foregoing implementations and embodiments can be combined in any appropriate manner . To avoid unnecessary repetition, other possible combinations will not be described in the present disclosure.

In addition, different implementations of this disclosure may alternatively be combined. Such combinations should also be considered as the content disclosed in this disclosure provided that these combinations do not depart from the concept of this disclosure.

1. A metal-based aluminum nitride composite material, comprising an aluminum nitride ceramic skeleton and a metal, wherein the metal fills at least part of pores of the aluminum nitride ceramic skeleton, the aluminum nitride ceramic skeleton contains aluminum nitride and CuAlO₂, and the aluminum nitride ceramic skeleton has a porosity of 20% to 40% 20 to 110 percent.

2. The composite material according to claim 1, wherein the content of the CuAlO₂ is 5% to 20% by weight based on the total amount of the aluminum nitride ceramic skeleton.

3. The composite material according to claim 1, wherein the metal includes one or more of aluminum, an aluminum alloy, copper, and a copper alloy.

4. The composite material according to claim 2, wherein
the aluminum nitride ceramic skeleton further comprises at least one of a zirconium oxide and a manganese oxide attached to the surfaces of at least part of pores of the aluminum nitride ceramic skeleton; and
the weight ratio of the aluminum nitride ceramic skeleton to the zirconium oxide is 1:(0 to 0.05), or the weight ratio of the aluminum nitride ceramic skeleton to the manganese oxide is 1:(0 to 0.05), or the weight ratio of the aluminum nitride ceramic skeleton to the zirconium oxide and the manganese oxide is 1:(0 to 0.05).

5. The composite material according to claim 1, wherein
the aluminum nitride ceramic skeleton contains a copper oxide, and the copper oxide comprises at least one of cupric oxide and cuprous oxide; and
the content of the copper oxide is 0% to 3% by weight based on the total amount of the aluminum nitride ceramic skeleton.

6. The composite material according to claim 1, wherein
the aluminum nitride ceramic skeleton further contains MnO₂, MnO, and Al₂O₃, and based on the total amount of the aluminum nitride ceramic skeleton, the content of the MnO2 is 0% to 3% by weight or 1% to 2% by weight, the content of the MnO is 0% to 3% by weight or 1% to 2% by weight, and the content of the Al₂O₃ is 0% to 5% by weight or 2% to 4% by weight.

7. The composite material according to claim 1, wherein the aluminum nitride ceramic skeleton contains aluminum nitride, CuAlO₂, cupric oxide and/or cuprous oxide, MnO₂, MnO, Al₂O₃, Y₂O₃, YAlO₃, and carbon; and
based on the total weight of aluminum nitride ceramic, the content of the aluminum nitride is 70% to 90% by weight, the content of the CuAlO₂ is 5% to 20% by weight, the content of the cupric oxide is 0% to 1% by weight, the content of the cuprous oxide is 0% to 1% by weight, the content of the MnO₂ is 0% to 2% by weight, the content of the MnO is 0% to 2% by weight, the content of the Al₂O₃ is 1% to 5% by weight, the content of the Y₂O₃ is 1% to 3% by weight, the content of the YAlO₃ is 3% to 5% by weight, and the balance is the carbon.

8. A method for preparing a metal-based aluminum nitride composite material, comprising:
sequentially mixing, drying, smashing, press-molding, and sintering a raw material containing aluminum nitride particles, copper oxide powder, and a binder to fabricate an aluminum nitride ceramic skeleton, wherein the copper oxide powder comprises at least one of cupric oxide powder and cuprous oxide powder; and
filling at least part of pores of the aluminum nitride ceramic skeleton with molten metal by a gas pressure infiltration.

9. The method according to claim 8, wherein
the raw material further contains a manganese source, and the manganese source comprises manganese salt, the manganese salt comprises at least one of manganese nitrate and manganese silicate; or
the raw material further contains a yttrium source, and the yttrium source comprises yttrium oxide.

10. The method according to claim 9, wherein the raw material contains aluminum nitride particles, at least one of cupric oxide powder and cuprous oxide powder, yttrium oxide, manganese silicate, manganese nitrate, and a binder, and does not contain a pore former, wherein the pore former consists of one or more selected from starch, stearic acid, and carbon powder; and
based on the total weight of the raw material, the usage amount of the aluminum nitride particles is 79% to 90% by weight, the usage amount of the yttrium oxide is 2% to 10% by weight, the usage amount of the cupric oxide powder is 0% to 10% by weight, the usage amount of the cuprous oxide powder is 0% to 10% by weight, the usage amount of the manganese nitrate is 0% to 10% by weight, the balance is the binder by dry weight, and the contents of the cupric oxide powder and the cuprous oxide powder are not 0 at the same time.

11. The method according to claim 8, wherein the sintering comprises:
heating from a room temperature to a first temperature of 150 to 350° C., maintaining the first temperature for 1 to 3 hours, then heating to a second temperature of 1,000 to 1,300° C., and maintaining the second temperature for 2 to 5 hours; or
heating from the room temperature to a third temperature of 180 to 300° C., maintaining the third temperature for 1.5 to 3 hours, and then heating to a fourth temperature of 1,050 to 1,200° C., and maintaining the fourth temperature for 2 to 5 hours; or
heating from the room temperature to a fifth temperature of 200 to 300° C., maintaining the fifth temperature for 2 to 3 hours, and then heating to a sixth temperature of 1,050 to 1,150° C., and maintaining the sixth temperature for 2 to 3 hours; and
the wherein a temperature increase rate in the heating is 2 to 10° C./minute, or 2 to 7° C./minute, or 3 to 5° C./minute.

12. The method according to claim 8, wherein
the binder comprises at least one of a polyvinyl alcohol aqueous solution, a polyvinyl butyral (PVB) alcoholic solution, and epoxy resin; and
the concentration of the polyvinyl alcohol aqueous solution is 5% to 20% by weight or 8% to 12% by weight.

13. (canceled)

14. The method according to claim 8, further comprising:
after sintering, immersing the aluminum nitride ceramic skeleton in a nitrate solution, drying the aluminum nitride ceramic skeleton, and calcining the aluminum nitride ceramic skeleton in an inert atmosphere to form a zirconium oxide and/or manganese oxide on the surfaces of at least part of the pores of the aluminum nitride ceramic skeleton, wherein
the concentration of the nitrate solution is 0.001 to 0.1 mol/L, the nitrate comprises at least one of manganese nitrate and zirconium nitrate, and the drying is conducted at a temperature of 60 to 350° C.

15. (canceled)

16. The method according to claim 8, wherein the metal comprises one or more of aluminum, an aluminum alloy, copper, and a copper alloy; and
based on the total volume of the obtained composite material, the content of the aluminum nitride ceramic skeleton is 60% to 80% by volume or 65% to 75% by volume.

17. The method according to claim 8, wherein the gas pressure infiltration comprises: putting the aluminum nitride ceramic skeleton into a mold, placing the mold in an infiltration apparatus furnace chamber, preheating the mold, pouring the molten metal into the mold, maintaining the mold at an elevated temperature, removing air from the chamber, feeding nitrogen to the chamber, and cooling, wherein the mold is preheated to 500 to 700° C., the elevated temperature is 650 to 800° C., and at the nitrogen is fed to the chamber to a pressure of 4 to 10 MPa.

18.-19. (canceled)

20. the composite material according to claim 3, wherein the content of the aluminum nitride ceramic skeleton is 60% to 80% by volume based on the total volume of the composite material.

21. The composite material according to claim 4, wherein the weight ratio of the aluminum nitride ceramic skeleton to the zirconium oxide is 1:(0 to 0.03), or the weight ratio of the aluminum nitride ceramic skeleton to the manganese oxide is 1:(0 to 0.03), or the weight ratio of the aluminum nitride ceramic skeleton to the zirconium oxide and the manganese oxide is 1:(0 to 0.03).

22. The composite material according to claim 5, wherein the content of the copper oxide is 0.1% to 1% by weight based on the total amount of the aluminum nitride ceramic skeleton.

23. The composite material according to claim 6, wherein:
the aluminum nitride ceramic skeleton further contains Y₂O₃ and YAlO₃; and
based on the total amount of the aluminum nitride ceramic skeleton, the content of the Y₂O₃ is 1% to 5% by weight, and the content of the YAlO₃ is 1% to 10% by weight.

24. The composite material according to claim 7, wherein based on the total weight of the aluminum nitride ceramic, the content of the aluminum nitride is 80% to 90% by weight, the content of the CuAlO₂ is 5% to 15% by weight, the content of the cupric oxide is 0.05% to 0.5% by weight, the content of the cuprous oxide is 0.05% to 0.5% by weight, the content of the MnO₂ is 1% to 1.5% by weight, the content of the MnO is 1% to 1.5% by weight, the content of the Al₂O₃ is 2% to 4% by weight, the content of the Y₂O₃ is 1% to 2% by weight, the content of the YAlO₃ is 3% to 4% by weight, and the balance is the carbon.
